(19) United States
(12) Patent Application Publication
(10) Pub. No.: US 2015/0161691 A1
(43) Pub. Date: Jun. 11, 2015

(54) SUBSCRIPTION AUTO REKEY

(71) Applicant: SoftNAS, LLC, Houston, TX (US)

(72) Inventor: Rick Gene Braddy, Houston, TX (US)

(73) Assignee: SOFTNAS, LLC, Houston, TX (US)

(21) Appl. No.: 14/562,438

(22) Filed: Dec. 5, 2014

Related U.S. Application Data
(60) Provisional application No. 61/913,237, filed on Dec. 6, 2013.

(51) Int. Cl. G06Q 30/06; G06Q 20/14; G06Q 10/00

(52) U.S. Cl. CPC G06Q 30/06; G06Q 10/00; G06Q 20/145

(57) ABSTRACT

A method of automatically renewing a software license. The method includes providing a license and a license key having a first predetermined term for an article of software. The software can be configured stop working when a valid license key is not present on a system running the software. The method includes receiving the license key and owner information and installing the software and the license key to a system and thereafter recording the license key in license table which is remote from the system running the software. Thereafter, if the term of the license is about to expire, an e-commerce table is consulted to determine whether an auto-renewal payment has been received, and if so, a renewal license key is downloaded and installed, thereby extending the term of the license and enabling the system to continue to run the software.

### CROSS-REFERENCE TO RELATED APPLICATION

This application claims priority to U.S. Provisional Application No. 61/913,237, filed Dec. 6, 2013, the contents of which are entirely incorporated by reference herein.

### FIELD

The subject matter herein generally relates to providing a method of automatically providing license keys to a system running licensed software.

### BRIEF DESCRIPTION OF THE DRAWINGS

Implementations of the present technology will now be described, by way of example only, with reference to the attached figures, wherein:

FIG. 1 is an example of a possible system architecture implementing the current disclosed subject matter;

FIG. 2 is an example of a method according to the present disclosure; and

FIG. 3 another example of a method according to the present disclosure.

### DETAILED DESCRIPTION

For simplicity and clarity of illustration, where appropriate, reference numerals have been repeated among the different figures to indicate corresponding or analogous elements. In addition, numerous specific details are set forth in order to provide a thorough understanding of the implementations described herein. However, the implementations described herein can be practiced without these specific details. In other instances, methods, procedures and components have not been described in detail so as not to obscure the related relevant feature being described. Also, the description is not to be considered as limiting the scope of the implementations described herein.

Several definitions that apply throughout this disclosure will now be presented. The term coupled is defined as directly or indirectly connected to one or more components. The term server can include a hardware server, a virtual machine, and a software server.

In at least one embodiment, the present technology can be implemented as a software module or a hardware module, or both. In at least one embodiment, the present technology causes a processor to execute instructions. The software module can be stored within a memory device or a drive. Hypertext Transfer Protocol Secure (HTTPS) is a communications protocol for secure communication over a computer network, with especially wide deployment on the Internet. Technically, it is not a protocol in and of itself; rather, it is the result of simply layering the Hypertext Transfer Protocol (HTTP) on top of the SSL/TLS protocol, thus adding the security capabilities of SSL/TLS to standard HTTP communications.

The present technology can be implemented with a variety of different drive configurations including Network File System (NFS), internet Small Computer System Interface (iSCSi), and Common Internet File System (CIFS). Additionally, the present technology can be configured to run on VMware ESXi (which is an operating system-independent hypervisor based on the VMkernel operating system interfacing with agents that run on top of it. Additionally, the present technology can be configured to run on Amazon® Web Service in VPC.

One embodiment within this disclosure is a method of automatically renewing a software license. The method can include providing a license (often for a fee) and a license key having a first predetermined term for an article of software, with the software configured to cease operation when a valid license key is no longer present on a system running the software. The method can also include receiving the license key and owner information corresponding to the owner of the license and thereafter installing the software and the license key to a system. The method can also include recording the license key in a license table which is remote from the system running the software—in usual operation this license table would be under the exclusive control of the owner of software granting the license. The method can also include determining that the term of the license will expire within a predetermined time—in other words that the software license is about to expire, and thereafter automatically consulting an e-commerce table to determine whether an auto-renewal payment was successfully received (from the licensee). If the auto-renewal payment was successfully received, the method can then automatically download and install a renewal license key having a second predetermined term to the system running the software. The license can thereby be extended, enabling the system to continue to run the software beyond the first predetermined term. The process of determining that a pending license is soon to expire and automatically checking for renewal payment and reinstallation can be done on an iterative basis.

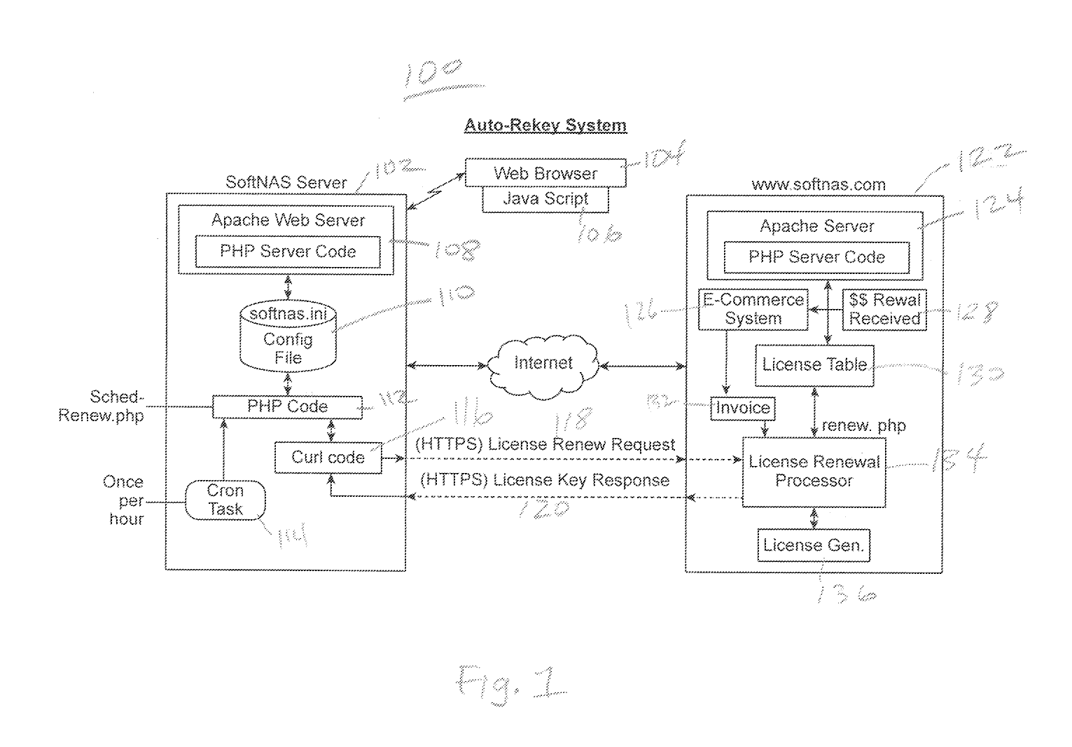

FIG. 1 is an example of a possible system 100 architecture implementing the current disclosed subject matter. A first server 102 is shown. The first server 102 can be running licensed software as described above. The first server 102 can be in signal communication with a device running a web browser 104, which can be run using programs such as javasript 106. The web browser 104 can be used to implement command and instructions to, and receive information from, the first server 102. The first server 102 can include or be coupled to an Apache Web Server 108. As shown, the Apache Web Server 108 can be coupled to a storage unit 110 storing one or more configuration files. Also within the first server 102, is at least one block of PHP code 112, which contains renewal schedule instructions. The PHP code 112 can execute a chronologic task once per hour (or other suitable period) to check whether renewal of licensed software is necessary. The PHP code 112 can interact with curl code to execute a request 118 for a renewal key and receive 120 a renewal key, from a remote server 122. The remote server 122 can contain or be in communication with an Apache Web Server 124. The remote server 122 can execute various functions. The Apache Web Server can consult with an e-commerce system 126 to determine whether payment for a renewal license has been received 128. The e-commerce system 126 can interact with an invoicing system 132 to seek and receive payment for license renewals. Remote server 122 can contain a license renewal processor 134 which consults with the license table 130 and generates renewed licenses and new license keys when appropriate payments have been received. These renewed licenses are conveyed 120 to the first server 102, so that the first server can continue to run the licensed software in question.

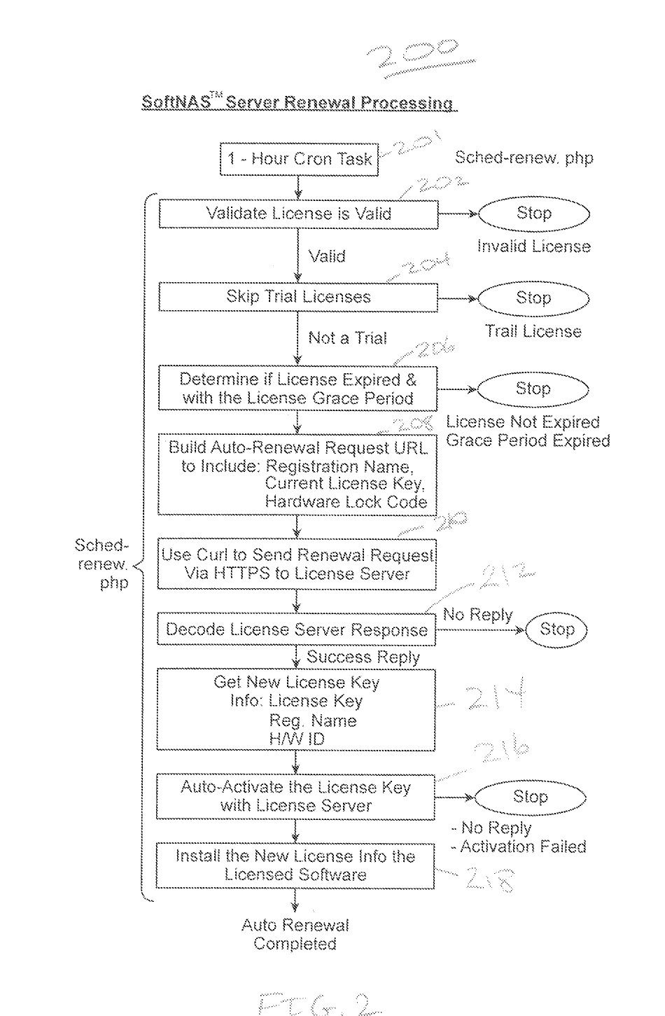

FIG. 2 illustrates a method 200 of renewal processing. This method can be configured to run once every hour 201 (or other suitable period). The method begins at step 202, where a determination is made as to whether the license for the software running on a system is valid. If the license is not valid, the method 200 stops (and the software will cease to run). If the license is valid, the method proceeds to step 204, where a determination is made as to whether the license is a trial license, if the license is a trial license, the method stops (and the software will continue to run). If the license is not a trial license, the method continues to step 206, where a determination is made if the license is expired and is within a predetermined grace period. If the license is not expired and is not within the grace period, the method 200 stops. If the license is expired and is within the grace period, the method proceeds to step 208, which includes building an auto-renewal request. The method then proceeds to step 210, where a renewal request is sent to a remote server via HTTPS. The method then proceeds to step 212, where it is determined whether response from the remote server indicating a renewal of the license has been received. If not, the method stops. If a response has been successfully received, the method 200 proceeds to step 214, in which new license key information is retrieved. The method 200 then moves to step 216, wherein the new license key is activated. The method 200 then stops. If however, at step 216 the activation failed, the method 200 proceeds to step 218, where the new license information is installed into the licensed software, thereby enabling the software to continue to run.

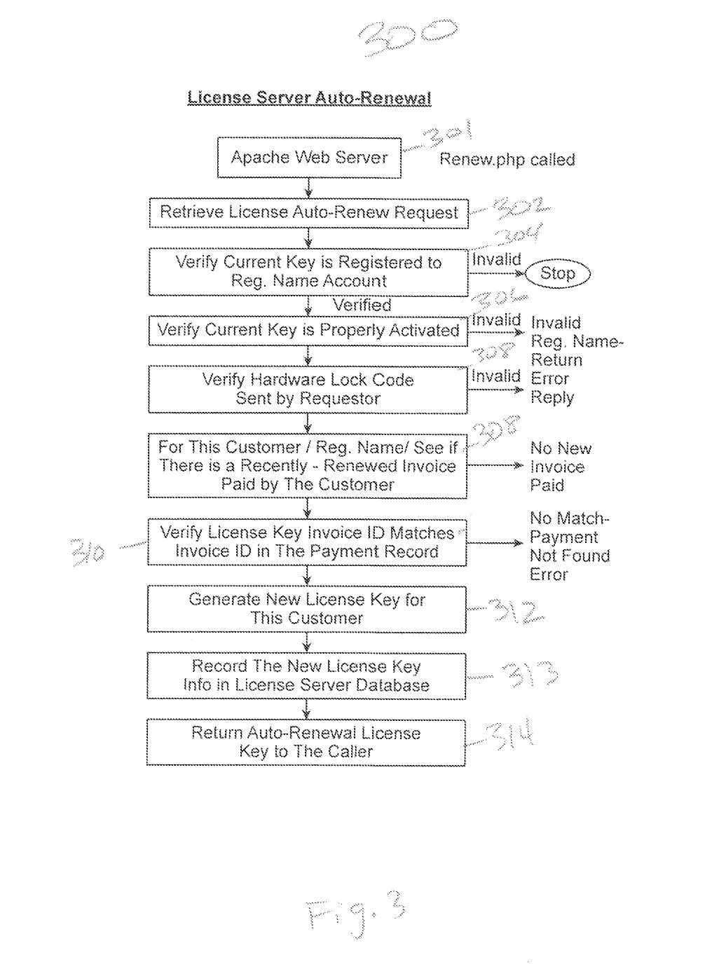

The present disclosure also includes a method 300 as illustrated with respect to FIG. 3. The method can be run on an Apache Web Server 301 or other servers. As illustrated, the method includes several steps. As with method 200, the steps illustrated are for illustration purposes and other steps can be implemented. Additionally, as with method 200, while a particular order is illustrated in FIG. 3, the present technology can be implemented in other arrangements such that the order of the steps can be different than that as illustrated. Furthermore, the present technology can include steps that are not illustrated and other embodiments can be such that one or more of the steps are removed. The method is described in relation to two servers, which can be any device as described above. For example, the servers as described below can be network attached storage devices.

The method 300 comprises retrieving (302) a license auto-renewal request. After step 302 is completed, the method 300 proceeds to step 304 where a determination is made as to whether a current key is registered to a registered account name. If not, the method stops. If registration is verified, the method 300 proceeds to step 306, where a determination is made as to whether the current key is properly activated. If it is not properly activated, the method 300 stops. If the current key is properly activated, the method 300 proceeds to step 308 to whether a hardware lock code has been send by a requestor. The method 300 then proceeds to step 308 where a determination is made as to whether a renewal payment for the license in question has been received. If it has not, the method 300 stops. If such payment is verified, the method 300 proceeds to step 310, where a determination is made as to whether a license key invoice matches an invoice identifier in a payment record. If there is no match, the method 300 stops. If there is a match, the method 300 proceeds to step 312, wherein a new license key is generated. The method 300 then proceeds to step 313, in which new license key information is recording in a license server database. The method 300 then proceeds to step 314, in which an auto-renewal license key is returned to the calling party, thereby enabling the licensed software to continue to run.

Examples within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, without departing from the scope of the disclosure.

What is claimed is:

1. A method of automatically renewing a software license, the method comprising:
providing a license and a license key having a first predetermined term for an article of software, the software configured to cease operation when a valid license key is not installed on a system running the software;
receiving the license key and owner information corresponding to the owner of the license, installing the software and the license key to a system;
recording the license key in a remote license table;
determining that the term of the license will expire within a predetermined time;
consulting an e-commerce table to determine whether an auto-renewal payment was successfully received;
if the auto-renewal payment was successfully received, automatically downloading and installing a renewal license key having a second predetermined term to the system running the software, thereby extending the term of the license and enabling the system to continue to run the software beyond the first predetermined term.

2. The method of claim 1, wherein the first predetermined period is thirty days.

3. The method of claim 1, wherein the second predetermined period is thirty days.

4. The method of claim 1, wherein the first predetermined time is seven days.

5. The method of claim 1, wherein the first predetermined time is one year.

6. A method of automatically renewing a software license, the method comprising:
providing a license and a license key having a first predetermined term for an article of software, the software configured to limit operation when a valid license key is not installed on a system running the software;
receiving the license key and owner information corresponding to the owner of the license, installing the software and the license key to a system;
recording the license key in a remote license table;
determining that the term of the license will expire within a predetermined time;
consulting an e-commerce table to determine whether an auto-renewal payment was successfully received;
if the auto-renewal payment was successfully received, automatically downloading and installing a renewal license key having a second predetermined term to the system running the software, thereby extending the term of the license and enabling the system to continue to run the software beyond the first predetermined term.

7. The method of claim 6, wherein the first predetermined period is thirty days.

8. The method of claim 6, wherein the second predetermined period is thirty days.

9. The method of claim 6, wherein the first predetermined time is seven days.

10. The method of claim 6, wherein the first predetermined time is one year.
